(19) United States
(12) Patent Application Publication
(10) Pub. No.: US 2015/0026074 A1
(43) Pub. Date: Jan. 22, 2015

(54) CONSUMER-CENTRIC PRODUCT WARRANTY MANAGEMENT SYSTEM

(71) Applicant: Roderick L. Cotten, Hernando, FL (US)

(72) Inventor: Roderick L. Cotten, Hernando, FL (US)

(21) Appl. No.: 13/948,122

(22) Filed: Jul. 22, 2013

(51) Int. Cl. G06Q 30/00

(52) U.S. Cl. CPC G06Q 30/012
USPC 705/302

(57) ABSTRACT

Consumer-centric communications-enabled portable, preferably tablet or smartphone-based, systems, methods and apparatus for product registration and warranty activation, and for product warranty management.

### FIELD OF THE INVENTION

The present invention relates to systems, methods and apparatus for product warranty management, generally, and to consumer-centric smartphone-based systems, methods and apparatus therefore in particular.

### BACKGROUND

The tedious process of registering a newly purchased product with the manufacturer, retailer or third party warrantor for the purpose of activating a product warranty, and completing the warranty activation process itself are often ignored by purchasers as too burdonsome and time consuming. Such processes often include filling out a warranty form with various required information including product information including but not limited to the product name, product brand, product category, product model, product serial number, date of product manufacture, product warranty information including length and terms of warranty, product repair center contact information and the like (together “Product Information”), customer information including customer name, customer address, customer phone numbers, and customer email address (together “Customer information” or “Purchaser Information”) as well as purchase information including proof-of-purchase, purchase date, purchase time, purchase location including store number, reason for purchase, intended use of product and other such information (together Purchase Information), and then mailing in the completed form and required attachments such as proof-of-purchase in the form of images of the purchased product, a sales receipt and/or UPC symbol or other portion of the product packaging (“Proof-of-Purchase” or “POP”). Even purchasers of products associated with a high frequency of repair needs in the near future, such as electronics or lawn maintenance equipment, for example, avoid submitting the warranty registration until actual breakdowns occur. Moreover, even when the purchaser goes through the effort of submitting the requisite Proof-Of-Purchase, Product Information, Customer Information and Purchase Information to the manufacturer, retailer or third party warrantor, it is not uncommon for the purchaser to neglect to retain copies of these documents or to forget where they have been stored, frustrating any future claim process. The purchaser will likely be unable to recall where and/or when the item requiring repair or replacement was purchased let alone retrieve copies of the warranty registration information.

There have been proposed various systems, methods and apparatus developed for facilitating or automating product warranty registration. All such systems, methods and apparatus, however, are “warrantor-centric,” meaning that each individual warrantor, whether it be a retailer, manufacturer, or third party after-market warrantor, serves as the central depository for warranties issued for its products. Consumers are merely the spokes on the warrantor system hub. Accordingly, while such systems, methods and apparatus may be helpful for the warrantor in organizing and managing the warranties it has issued for its warranted products and/or facilitating the product registration and claims processes, they do not necessarily make it easier for the consumer to register their products for warranty purposes or to organize, manage and store their multitude of product warranties using a single device, namely their personal computing device.

Accordingly, there is a need for a consumer-centric system and method for facilitating product registration and warranty activation, and a means for storing, organizing and retrieving product warranty information with greater ease than heretofore realized, a means for tracking product warranty expiration dates and alerting the consumer in advance of an expiring product warranty, and means for facilitating the warranty claims process including facilitating product returns and product repairs.

All patents, patent applications, provisional applications, and publications referred to or cited herein, or from which a claim for benefit of priority has been made, are incorporated herein by reference in their entirety to the extent they are not inconsistent with the explicit teachings of this specification.

### SUMMARY OF THE INVENTION

The present invention solves the need in the art by providing consumer-centric communications-enabled portable, preferably tablet or smartphone-based, systems, methods and apparatus for product registration and warranty activation and management including claims processing. More particularly, as a system, the invention comprises a local computing device operated by a consumer, at least one remote computing device operated by a warrantying party such as a manufacturer, retailer or third party warrantor, and a communication infrastructure therebetween, the computing device being preferably but not essentially a hand-held device such as a tablet pc or smartphone having an onboard or peripheral camera or other code scanning/reading device and a product warranty management application for capturing, storing, categorizing, sorting and displaying Proof-Of-Purchase, and for capturing, reading, storing, categorizing, sorting and displaying Product Information and Purchase Information recorded on the product, product packaging and/or product sales receipt, usually in the form of a barcoded machine-readable label, and communication means for transmitting and receiving data to and from the product warrantor via the communication infrastructure for purposes of carrying out product registration, warranty activation and claims processing The communication infrastructure can be wired, wireless or any suitable hybrid thereof, and preferably comprises one or more of a phone network or a data network. More specifically, the communication infrastructure comprises one or more of the Internet, Intranet, telephone interface, cellular interface, satellite, or the like. The code scanner and code reader application can scan product UPC's and/or the image of a barcode, such as a OR code, to: 1) display Product Information, 2) connect to a wireless network such as that of the retailer to carry out product registration and warranty activation, and/or 3) open a web page in the computing device's web browser (hardlinking) such as a web page of the product manufacturer through which the product can be registered and its warranty issued. The computing device and product warranty management application together provide a variety of functional features including, for example, receiving warranty expiration alerts, extended warranty options, and claim processing information including product return authoriation codes and mailing labels for instance.

Accordingly, the subject invention in one embodiment is a computer implemented method for carrying out product registration, warranty activation and claims processing with manufacturers, retailers and/or third party warrantors, said method being implemented using a product warranty management application running on a computing device in communication with at least one remote warrantor operated computer via a communication infrastructure, said method comprising the steps of: a) entering (only once) and storing Purchaser Information into the warranty management application, b) capturing with the computing device's camera and then storing in the computing device Proof-Of-Purchase, e) capturing with the computing device's code reader barcoded Product Information and Purchase Information printed on the product packaging and/or sales receipt and required for product registration and/or product warranty activation, d) reading said barcode with a code reader application or circuitry thereby translating the code into alpha-numeric text data, e) storing in the computing device said alpha-numeric text data for later retrieval, f) transmitting from said computing device to a product warrantor via said communication infrastructure a request for product registration and/or product warranty activation, said request including all warrantor-required data including said Purchaser Information, said Purchase Information, said Proof-Of-Purchase, and at least one of said barcoded Product Information and said human-readable (decoded) Product Information for validation against a central database of said warrantor, g) receiving and storing on said computing device confirmation of product registration and/or warranty activation from said product warrantor. The above-referenced encoded product data is typically a code printed on an optically machine-readable label affixed to the product or product packaging. Other methods include the additional steps of categorizing, sorting and displaying on said computing device proof-of-purchase, purchase data, product information and/or product warrantes; scheduling and receiving product warranty expiration alerts; receiving extended warranty offerings; and processing warranty claims including product return or product repair requests.

In another embodiment the subject invention is an article of manufacture embodied in a machine storage medium including data that, when accessed by a machine, cause a computer processor in the machine to carry out the above steps.

The invention further includes other methods and apparatus of varying scope.

There has thus been outlined, rather broadly, the more important components of the system of the subject invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

By virtue of the herein described systems, methods and apparatus a primary objective of the subject invention may be achieved, namely providing a personal computing device specifically intended for use by consumers to activate and manage their product warranties, the device including an alert system for notifying the user of forthcoming warranty expirations so that the consumer can take appropriate action (i.e., consider purchasing an extended warranty if available or a product replacement or backup).

This together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 illustrates a product warranty management system according to the teachings of the present invention, the system comprising a local computing device operated by a consumer, at least one remote computing device operated by a warrantying party such as a manufacturer, retailer or third party warrantor, and a communication infrastructure therebetween; and

FIG. 2 is a flow chart of a method of carrying out product registration and/or product warranty activation with manufacturers, retailers and/or third party warrantors, the method being implemented using a product warranty management application running on a computing device in communication with at least one remote warrantor operated computer via a communication infrastructure.

It should be understood that in certain situations for reasons of computational efficiency or ease of maintenance, the ordering of the blocks of the illustrated flow charts could be rearranged or moved inside or outside of the illustrated loops by one skilled in the art. While the present invention will be described with reference to the details of the embodiments of the invention shown in the drawing, these details are not intended to limit the scope of the invention.

### DETAILED DESCRIPTION OF PREFERRED EMBODIMENTS

Reference will now be made in detail to the embodiments consistent with the invention, examples of which are illustrated in the accompanying drawings. Wherever possible, the same reference numerals used throughout the drawings refer to the same or like parts. The terms “user,” “purchaser” and ‘consumer’ are used interchangeably herein and refer to a person who desires to register purchased products with the products' manufacturer, retailer and/or third party warrantor (“warrantor(s)”) for the purpose of activating a product warranty, organizing and managing said warranties including their expiration dates, and filing warranty claims with the warrantor(s).

The present application therefore is directed to a consumer-centric product warranty and management systems, methods and apparatus for, inter alia, facilitating product registration with manufacturers, retailers and/or third party warrantors for the purpose of, inter alia, activating product warranties, and for organizing and managing a plurality of warranties associated with a single consumer, said method being implemented using a computer application running on or accessible by a computing device as herein described in detail.

The subject systems, methods and apparatus for product warranty registration and management leverage well known and widely used barcode technology. Barcodes, including linear bar codes such as the Universal Product Codes (UPCs) widely used for tracking trade items in stores, and matrix barcodes (or two-dimensional barcodes) such as the Quick Response (QR) brand of codes which are optically machine-readable labels. In the instant application, The Product Information and Purchase Information that the manufacturer, retailer or third party warrantor requires for product registration and/or product warranty activation is is made available to the consumer in the form of barcodes generated and printed by the manufacture on the product and/or its packaging and by retailers on the product purchase sales receipt at the point-of-sale, oftentimes alongside the equivalent alpha-numeric text data. Product Information may include some or all of the following information, without limitation: product name, product brand, product category. product model, product serial number, date of product manufacture, product warranty information including length and terms of warranty, and product repair center contact information. Purchase Information may include some or all of the following information, without limitation: proof-of-purchase, purchase date, purchase time, purchase location including store number, reason for purchase, and intended use of product. Rather than filling out tedious forms, whether in paper form or digital (such as made available on the warrantor's website), the consumer can provide the required information literally with a touch of a button or two (or facsimiles thereof) while simultaneously creating and storing a searchable record of the transaction using the below described systems, methods and apparatus for product warranty registration and management.

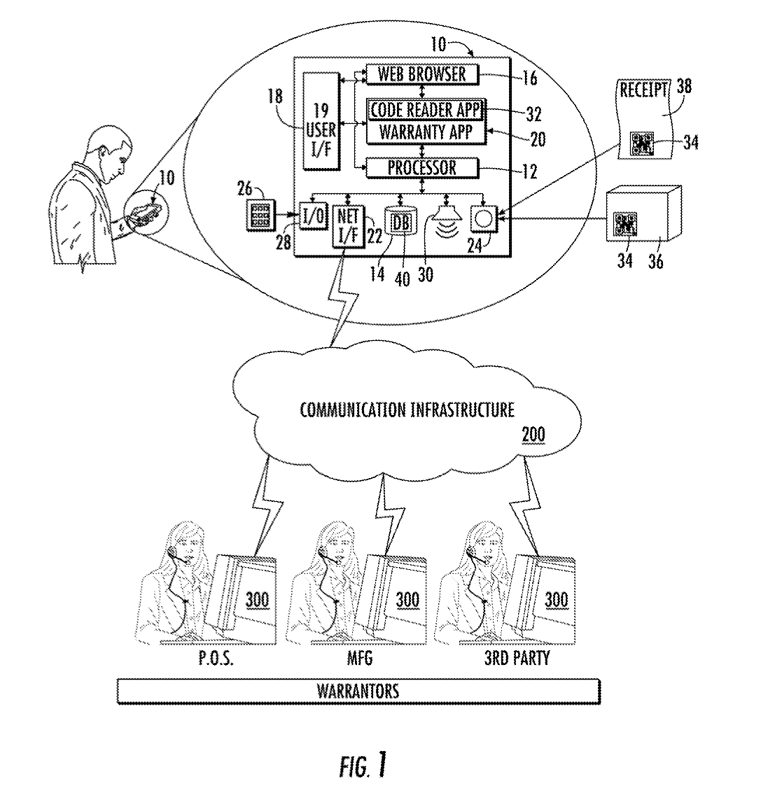

Turning now specifically to FIG. 1, an embodiment of the subject invention as a system is comprised very generally of a network-enabled consumer operated personal computing device 10 (also referred to herein more simply as “computing device”), operable to execute at a minimum a Product Warranty Management Application 20 (also referred to herein more simply as “Warranty Application” or “Warranty App”), at least one remote warrantor-operated computer 300 (hereinafter Warrantor Computer 300″) operated by a warrantying party such as a manufacturer, retailer or third party warrantor, and a communication infrastructure 200 therebetween.

Although not illustrated for purposes of clarity, Warrantor Computer 300 includes a processor, memory, a network interface video monitor, keyboard, mouse and other user input/output devices of the types commonly included in a terminal or workstation of a warrantor computer network. For purposes of clarity, the system is illustrated as a single or stand-alone computer, but as persons skilled in the art will recognize, the system can include multiple layers of servers (e.g., front-end and back-end) and storage devices as is common in the art for business systems.

Communication infrastructure 200 can be wired, wireless or any suitable hybrid thereof, and preferably comprises one or more of a phone network or a data network. More specifically, the communication infrastructure comprises one or more of the Internet, Intranet, telephone interface, cellular interface, satellite, or the like.

Computing device 10 is preferably but not essentially a portable computing device such as tablet pc, smartphone, laptop, or Personal Digital Assistant (“PDA”), but may be any type of computer or computer system, including a desktop personal computer, mainframe computer system, workstation, network appliance, Internet appliance, television system or other device.

As used herein, the term “tablet” means a wireless, portable personal computer with a touch screen interface, and may be, without limitation, of the slate, convertible or hybrid styles. A slate style tablet, like Apple's iPad or Microsoft's Surface, have electronics integrated into the touch screen unit and lack a hardware keyboard. A convertible tablet typically has a display that rotates 180 degrees and can be folded to close, screen up, over the integrated keyboard. Convertible models may allow user input through a variety of methods in addition to the hardware keyboard, including natural handwriting with a stylus or digital pen and typing through a screen-based software keyboard. A hybrid tablet, sometimes referred to as a convertible or hybrid notebook, is like a regular notebook but with a removable display that functions independently as a slate. In all instances, the tablet includes the above identified network and input capabilities.

As used herein, the term “PDA” means any mobile hand-held device that provides computing and information storage and retrieval capabilities as well as the above identified network and input capabilities.

As used herein the term “laptop”, also sometimes called notebook computer, notebook, ultrabook, netbook, etc., means any portable personal computer with a clamshell form factor, suitable for mobile use and including a display as well as the above identified network and input capabilities.

As used herein, the term “smartphone” means a mobile phone built on a mobile operating system and typically including a high-resolution touhscreen and web browsing capability for displaying standard web pages as well as mobile-optimized sites. High speed data access is provided by Wi-Fi and mobile broadband. The mobile operating systems (OS) used include, without limitation, Google's Android, Apple's iOS, Nokia's Symbian, RIM's BlackBerry OS, Samsungs's Bada, Microsoft's Windows Phone, Hewlett-Packards's webOS, and embedded Linux distributions such as Maerno and MeeGo. Other operating systems include Mozilla's Firefox OS, CanonicalLtd's Ubuntu Phone, and Tizen. Here again, the smartphone will include the above identified network and input capabilities.

In general, the term “computing device” can be broadly defined to encompass any device having at least one processor 12 that executes instructions from one or more computer programs or software components stored on a memory medium(s) 14. According to one embodiment of the present invention, memory medium 14 may store Warranty Application 20 itself and a Web browser 16. The memory medium may also store operating system software (not shown), such as those described above, as well as other software for operation of the computer system. The term “memory medium” is intended to include an installation medium, e.g., a CD-ROM, floppy disks, or tape device; a computer system memory or random access memory such as DRAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed (preferred), or may be located in a second different computer which connects to the first computer over a network, such as the Internet. In the latter instance, the second computer may provide program instructions to the first computer for execution.

Computing device 10 further includes a display device 18 such as a monitor, onboard display screen or touchscreen, each operable to display a graphical user interface 19. The graphical user interface may comprise any type of graphical user interface, e.g., depending on the computing platform. In the case of desktops and laptops the graphical user interface may comprise one or more windows, such as those used in window-based user interface systems such as provided by the Macintosh Operating System, Microsoft Windows, the X Window System, etc. For tablets and smartphones, the graphical user interface may comprise Symbian, BlackBerry OS, Android, Windows Phone, Palm OS /Web OS, and Apples's iOS. The graphical user interface may include a plurality of user interface elements, including indicators for displaying output and/or controls for specifying program input. Examples of user interface controls and indicators include charts, graphs, push buttons, knobs, numeric controls, text boxes, check boxes, list boxes, etc. The graphical user interface may also include any of various other types of user interface elements, such as menu bars, popup context menus, window close buttons, etc.

Computing device 10 is network accessible via a network interface 22 and further includes essential input/output devices including a preferably integrated code reader 24 and text data input means such as a virtual keyboard displayed by graphical user interface 19 on display 18, or an external text data input device 26 such as a keyboard or touchpad operably connected to an input/output interface 28. An audio output device (speaker) 30 is preferably but not essentially integrated (shown) or peripherally mounted though I/O interface 28 (not shown). Other optional input/output devices (not shown) such as, but not limited to, microphones (i.e., for voice recognition), vibrators for providing tactile alerts, and printers and scanners may also be included with corresponding device drivers.

In one embodiment, Warranty Application 20 is preferably a mobile application (aka “mobile app” or just “app”) designed to run on a mobile computing device 10, whether it be a smartphone, tablet or other mobile device. Warranty Application 20 can he pre-installed on the mobile computing device 10, installed from various storage media such as a CD or flash drive, or preferably downloaded to mobile computing device 10 from application distribution platforms, typically operated by the owner of the mobile operating system, such as from the Apple App Store, Google Play, Windows Phone Store, and BlackBerry App World via communications infrastructure 200. In alternative embodiments, Warranty Application 20 is either an executable program stored on a non-mobile computing device or is a web application accessible via web-browser 16 stored on computing device 10 over communications infrastructure 200 such as the Internet or an intranet.

Warranty Application 20 includes or works in conjunction with a code reader application 32 in operable communication with code reader 24 to read barcodes 34 attached to products 36 (or product packaging) and product purchase receipts 38 and that contain the required Product Information and/or Purchase Information in coded form. The Product Information and Purchase Information is that which the manufacturer or retailer requires for product registration and/or product warranty activation. As used herein, “code reader” means a barcode reader or barcode scanner for reading printed barcodes. “Code reader application” means decoder software or circuitry for analyzing the barcode's image data as provided by the code reader's light sensor which translates optical impulses into electrical ones which are sent via the scanner's output port to Warranty Application 20 for display on display device 18 as human-readable content. Types of barcode readers 24 employed by the subject product warranty management systems and methods include pen-type readers, laser scanners, CCD readers, camera-based readers that use a camera and image processing techniques to decode the barcode, video camera readers, large field-of-view readers, omni-diectional barcode scanners, or preferably cell phone cameras or smartphone cameras. The term “read” as used herein means translate the barcode into alpha-numeric text data.

Warranty Application 20 stores a copy of the scanned barcode and the alpha-numeric translation thereof in product warranty database 40 on memory medium 14. In preferred embodiments, code reader 24 is a camera integrated into a tablet or smartphone and can be used to record images of purchased products and proof-of-purchase documents including sales receipts and UPC codes, for instance, Warranty application 20 is also configured to categorize (such as by product type, manufacturer, etc.), sort, edit and display on display device 18 human-readable data comprising Product Information and Purchase Information, Proof-of-Purchase Information, as well as Consumer Information which need be entered by the user only once absent the need for subsequent changes thereto.

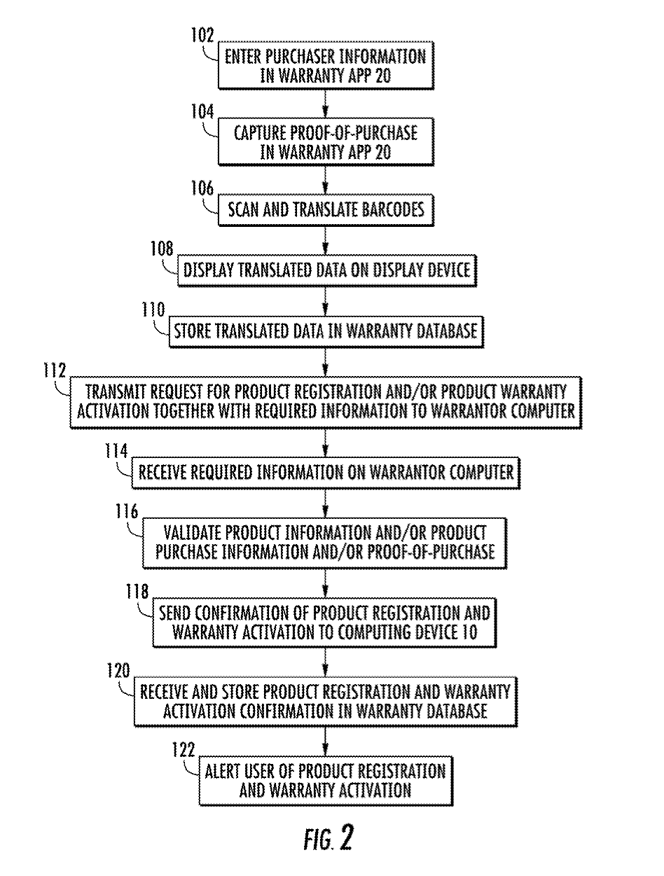

By virtue of the above described apparatus the subject methods may be achieved, namely facilitating new product registration for warranty purposes, organizing, managing and storing product warranties for possible future claim submission, and to facilitating claims submissions when necessary. With continued reference to FIG. 1, and additional reference to the flow diagram of FIG. 2, a first method of registering a product with a warrantor and activating a product warranty can be better understood. In the illustrated embodiment, at step 102 a user of the subject system enters Purchaser Information into Warranty Application 20 via various data entry devices and methods comprising keying information into device 10 using an integrated or external keyboard or a virtual keyboard associated with a touchscreen device, speaking into a microphone associated with voice recognition software, or scanning with a barcode reader a barcode previously generated by the user that stores the Purchaser Information. Warranty Application 20 then stores the Purchase Information in warranty database 40 for later retrieval. Regardless of the method of data entry used, this step need only be taken once unless the Purchaser Information changes (i.e., a change of address, phone number, email address, etc.) in which case Warranty Application 20 is configured for enabling edits of this information. The need to enter Purchase Information only once saves considerable time and effort in comparison with the conventional method of entering this information on each product registration or warranty activation form.

Proof of purchase is often required for filing of warranty claims as evidence that the customer purchased the product. Traditional proof of purchase systems required the consumer to send some portion of the packaging, as defined by the product's manufacturer, or the sales invoice. Unique codes printed on packaging are increasingly used as a mechanism for proof of purchase. With the subject product warranty management system, consumers can submit the code electronically for validation against a central database, thus establishing proof of purchase. In step 104, the user captures images of Proof-Of-Purchase in computing device 10 generally, and in warranty database 40 more specifically, preferably using an onboard camera found in most tablet pc's and smartphones. Alternatively, the user can capture POP images using a stand-alone camera, video camera or other optical device and transfer the images to computing device 10 and storage in warranty database 40. As previously stated, POP can be any one or more of images of the purchased product, a sales receipt and/or UPC symbol or other portion of the product packaging at the discretion of the warrantor.

Barcodes 34 are printed on product 24 and/or its packaging and/or on sales receipt 38 and contain, in encoded form, the Product Information and Purchase Information required by warrantor 300 for product registration and/or product warranty activation. In step 106, the user scans with code reader 24 barcode(s) 34 which causes code reader application 32 (or code reading circuitry) to translate (“read”) the barcode(s)' encoded Product Information and/or Purchase Information associated with a product 36 being registered and/or warranted into its alpha-numeric equivalent for display on display device 18 (step 108) and/or storage in warranty database 40 (step 110) for later retrieval. As an optional step (not illustrated), the user can also capture an image of each barcode 34 using camera 24 and store them on warranty database 40 either before or after step 106.

In step 112, user causes Warranty Application 20 to transmit to Warrantor Computer 300 via a communication infrastructure 200 a request for product registration and/or product warranty activation, said request including all warrantor-required data including Purchaser Information, decoded Purchase Information, Proof-Of-Purchase, and at least one of said barcoded Product information and said decoded Product Information for validation against a central database of the warrantor (together “Required Information”). In other embodiments, scanning of the product's barcode such as a QR code causes computing device 10 to load any recognized Web URLs on Web browser 16 of computing device 10 and automatically connect to Warrantor Computer 300 (hardlinking) to carry out product registration and warranty activation. In such embodiments, Warranty Application 20 can be configured to automatically transmit the Required Information to Warrantor Computer 300 rather than prompting the user to do so.

In step 114, Warrantor Computer 300 receives the Required Information from computing device 10. In step 116. Warrantor Computer 300 validates the Product information and/or product Purchase Information and/or the Proof-Of-Purchase, and in step 118 sends confirmation of product registration and warranty activation to computing device 10 via communications infrastructure 200. The warrantor may also send to computing device 10 further warranty information including warranty terms and conditions, dates of warranty period, instructions for submitting warranty claims, etc. (Warranty Information). In step 120, Warranty App 20 receives the product registration and warranty activation confirmation and stores it in warranty database 40 of computing device 10 for later retrieval. In step 122, Warranty App 20 also alerts the user to the receipt of product registration and warranty activation confirmation. The alert means comprises at least one of a visual sensory alert appearing on graphical user interface 19 of display device 18, an audible alert carried out by audio output device 30 or a tactile alert such as a vibration carried out by a vibrator device (not shown).

Other methods include the additional steps of categorizing, sorting and displaying on display device 18 of computing device 10 any or all of the Proofs-Of-Purchase, Product Information, Purchase Information and Warranty Information. Still other methods include the step of scheduling and receiving product warranty expiration alerts. When a warranty expiration date is transmitted by the warrantor to computing device 10, Warranty App 20 is configured to automatically enter the date in a warranty calendar module (not shown), store the date in warranty database 40 and alert the user via alert means on predefined notice dates (i.e., 90 days before expiration date). In the alternative, Warranty Application 20 is configured to prompt the user to manually enter the warranty expiration date(s) for each warranted product if said data is not furnished by the warrantor upon communication of warranty activation (step 118).

It will be readily appreciated that while the discussion herein focuses on a particular computing arrangement, it should be understood that the invention is not limited to the particular hardware designs, software designs, communications protocols, performance parameters, or application-specific functions disclosed herein. An apparatus for making, using or selling the invention may be one or more processing systems including, but not limited to, a central processing unit (CPU), memory, storage devices, communication links and devices, servers, 110 devices, or any sub-components of one or more processing systems, including software, firmware, hardware or any combination or subset thereof, which embody the invention as set forth in the claims. One skilled in the art of computer science will easily be able to combine the methods as described with appropriate general purpose or special purpose computer hardware/software to create a computer system or computer sub-system embodying the method of the invention.

While exemplary systems and methods embodying the present invention are shown by way of example, it will be understood, of course, that the invention is not limited to these embodiments. Modifications may be made by those skilled in the art, particularly in light of the foregoing teachings. For example, each of the elements of the aforementioned embodiments may be utilized alone or in combination with elements of the other embodiments.

What is claimed as being new, useful and desired to be protected by Letters Patent of the United States is as follows:

1. A computer implemented method for activating a product warranty by a consumer with a product warrantor, said method being implemented using a computer application running on a computing device in communication with at least one remote warrantor operated computer via a communication infrastructure, said method comprising the steps of:
a. entering by said consumer purchaser information into said computer application;
b. capturing by said consumer with an optical device associated with said computing device proof-of-purchase of a product and then storing said proof-of-purchase in said computing device;
c. scanning by said consumer with a code reader associated with said computing device and in operable communication with a code reader application at least one barcode comprising at least one of product information and purchase information associated with said product, thereby causing said code reader application to translate said at least one of product information and purchase information into alpha-numeric text;
d. transmitting from said computing device to said remote warrantor operated computer via said communication infrastructure a request for at least one of product registration and product warranty activation, said request including transmission of said purchaser information, said proof-of-purchase, said purchase information, and said product information for validation against a central database of said warrantor; and
e. receiving from said remote warrantor operated computer and storing on said computing device confirmation of said at least one of product registration and warranty activation.

2. The computer implemented method of claim 1, wherein said computing device is a mobile computing device and said application is a mobile application.

3. The computer implemented method of claim 1, wherein said optical device is integrated with said computing device or is a peripheral device connected to said computing device.

4. The computer implemented method of claim 2, wherein said optical device is integrated with said computing device or is a peripheral device connected to said computing device.

5. The computer implemented method of claim 1, wherein said optical device and said code reader are the same device.

6. The computer implemented method of claim 2, wherein said optical device and said code reader are the same device.

7. The computer implemented method of claim 3, wherein said optic device and said code reader are the same device.

8. The computer implemented method of claim 4, wherein said optical device and said code reader are the same device.

9. The computer implemented method of claim 1, wherein at least one of said product information and purchase information transmitted to said remote warrantor operated computer is transmitted in the form of said at least one barcode or its alpha-numeric equivalent.

10. The computer implemented method of claim 2, wherein at least one of said product information and purchase information transmitted to said remote warrantor operated computer is transmitted in the form of said at least one barcode or its alpha-numeric equivalent

11. The computer implemented method of claim 3, wherein at least one of said product information and purchase information transmitted to said remote warrantor operated computer is transmitted in the form of said at least one barcode or its alpha-numeric equivalent.

12. The computer implemented method of claim 4, wherein at least one of said product information and purchase information transmitted to said remote warrantor operated computer is transmitted in the form of said at least one barcode or its alpha-numeric equivalent.

13. The computer implemented method of claim 5, wherein at least one of said product information and purchase information transmitted to said remote warrantor operated computer is transmitted in the form of said at least one barcode or its alpha-numeric equivalent.

14. The computer implemented method of claim 6, wherein at least one of said product information and purchase information transmitted to said remote warrantor operated computer is transmitted in the form of said at least one barcode or its alpha-numeric equivalent.

15. The computer implemented method of claim 7, wherein at least one of said product information and purchase information transmitted to said remote warrantor operated computer is transmitted in the form of said at least one barcode or its alpha-numeric equivalent.

16. The computer implemented method of claim 8, wherein at least one of said product information and purchase information transmitted to said remote warrantor operated computer is transmitted in the form of said at least one barcode or its alpha-numeric equivalent.

17. The computer implemented method of claim 1, further including the steps of categorizing, sorting and displaying on said computing device proof-of-purchase, purchase information, product information, product registration data and product warranty data for multiple products.

18. The computer implemented method of claim 2, further including the steps of categorizing, sorting and displaying on said computing device proof-of-purchase, purchase information, product information, product registration data and product warranty data for multiple products.

19. The computer implemented method of claim 1, further including the steps of scheduling in said computer application a warranty expiration date and causing alert means associated with said computing device to alert said consumer of said expiration date on at least one predefined notice date.

20. The computer implemented method of claim 1, further including the steps of scheduling in said computer application a warranty expiration date and causing alert means associated with said computing device to alert said consumer of said expiration date on at least one predefined notice date.
